(19) United States
(12) Patent Application Publication
(10) Pub. No.: US 2005/0234929 A1
(43) Pub. Date: Oct. 20, 2005

(54) Methods and systems for interfacing applications with a search engine

(76) Inventors: Mihai Florin Ionescu, Mountain View, CA (US); Omar Habib Khan, Toronto (CA)

Correspondence Address: FENWICK & WEST LLP, SILICON VALLEY CENTER, 801 CALIFORNIA STREET, MOUNTAIN VIEW, CA, 94041, US

(21) Appl. No.: 10/814,387

(22) Filed: Mar. 31, 2004

(51) Int. Cl. G06F 7/00

(52) U.S. Cl. 707/100

(57) ABSTRACT

The present invention provides an application interface for a unified search engine. In one embodiment, an event schema is determined for an application, wherein the application has associated articles, event data is determined for an event, based at least in part on the event schema, wherein the event relates to user interactions with an article associated with the application, event data is transferred to a search application and stored in a searchable database, wherein the events and articles associated with the application are searchable by a search application.

### FIELD OF THE INVENTION

The invention generally relates to search engines. More particularly, the invention relates to methods and systems for interfacing applications with a search engine.

### BACKGROUND OF THE INVENTION

Users generate and access a large number of articles, such as emails, web pages, word processing documents, spreadsheet documents, instant messenger messages, and presentation documents, using a client device, such as a personal computer, personal digital assistant, or mobile phone. Some articles are stored on one or more storage devices coupled to, accessible by, or otherwise associated with the client device(s). Users sometimes wish to search the storage device(s) for articles.

Conventional client-device search applications may significantly degrade the performance of the client device. For example, certain conventional client-device search applications typically use batch processing to index all articles, which can result in noticeably slower performance of the client device during the batch processing. Additionally, batch processing occurs only periodically. Therefore, when a user performs a search, the most recent articles are sometimes not included in the results. Moreover, if the batch processing is scheduled for a time when the client device is not operational and is thus not performed for an extended period of time, the index of articles associated with the client device can become outdated. Conventional client-device search applications can also need to rebuild the index at each batch processing or build new partial indexes and perform a merge operation that can use a lot of client-device resources. Conventional client-device search applications also sometimes use a great deal of system resources when operational, resulting in slower performance of the client device.

Additionally, conventional client-device search applications can require an explicit search query from a user to generate results, and may be limited to examining file names or the contents of a particular application's files.

### SUMMARY

Embodiments of the present invention provide systems and methods for an application interface for unified searching. One embodiment comprises systems and methods for determining an event schema for an application, wherein the application has associated articles, determining event data for an event, based at least in part on the event schema, wherein the event relates to user interactions with an article associated with the application, transferring the event data to a search application and storing the event data in a searchable database, wherein the events and articles associated with an application are searchable by the search application.

This exemplary embodiment is mentioned not to limit or define the invention, but to provide an example of an embodiment of the invention to aid understanding thereof. Exemplary embodiments are discussed in the Detailed Description, and further description of the invention is provided there. Advantages offered by the various embodiments of the present invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram illustrating an exemplary operating environment, in accordance with one embodiment of the invention.

FIG. 2 is a block diagram illustrating components of an interface between an exemplary capture component and a search engine, in accordance with an embodiment of the invention.

FIG. 3 is a flow diagram illustrating an exemplary method in accordance with an embodiment of the invention.

FIG. 4 is another flow diagram illustrating an exemplary method in accordance with an embodiment of the invention.

### DETAILED DESCRIPTION OF SPECIFIC EMBODIMENTS

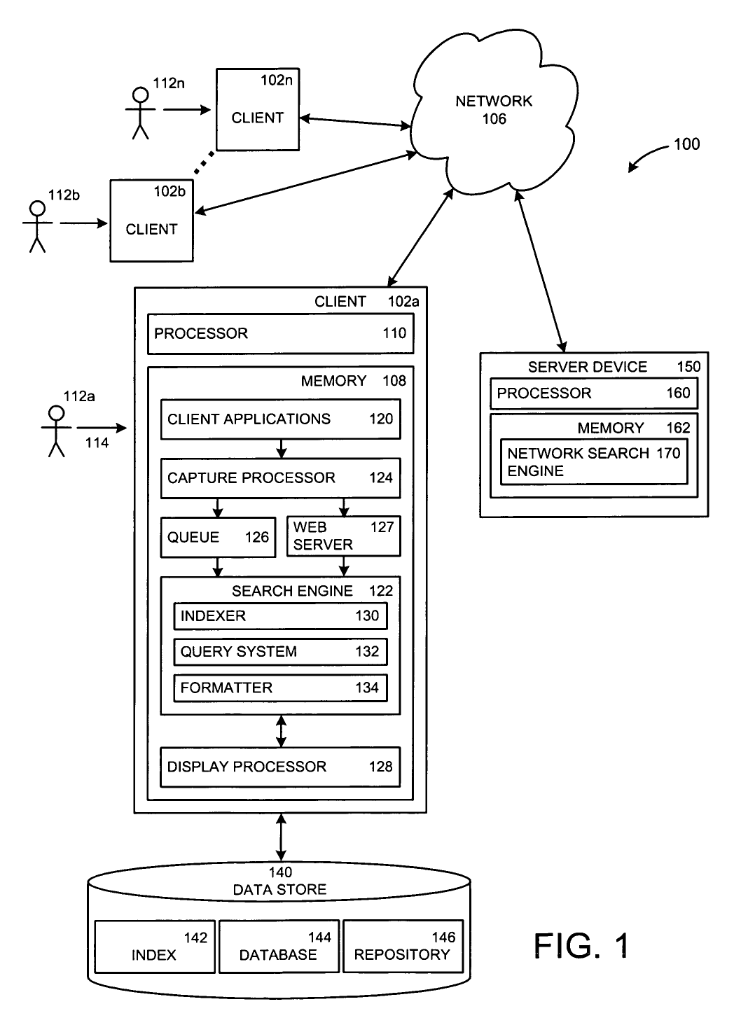

Referring now to the drawings in which like numerals indicate like elements throughout the several figures, FIG. 1 is a block diagram illustrating an exemplary environment for implementation of an embodiment of the present invention. While the environment shown in FIG. 1 reflects a client-side search engine architecture embodiment, other embodiments are possible. The system 100 shown in FIG. 1 includes multiple client devices 102a-n that can communicate with a server device 150 over a network 106. The network 106 shown in FIG. 1 comprises the Internet. In other embodiments, other networks, such as an intranet, may be used instead. Moreover, methods according to the present invention may operate within a single client device that does not communicate with a server device or a network.

The client devices 102a-n shown in FIG. 1 each include a computer-readable medium 108. The embodiment shown in FIG. 1 includes a random access memory (RAM) 108 coupled to a processor 110. The processor 110 executes computer-executable program instructions stored in memory 108. Such processors may include a microprocessor, an ASIC, state machines, or other processor, and can be any of a number of suitable computer processors, such as processors from Intel Corporation of Santa Clara, Calif. and Motorola Corporation of Schaumburg, Ill. Such processors include, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 110 of client 102a, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

Client devices 102a-n can be coupled to a network 106, or alternatively, can be stand alone machines. Client devices 102a-n may also include a number of external or internal devices such as a mouse, a CD-ROM, DVD, a keyboard, a display device, or other input or output devices. Examples of client devices 102a-n are personal computers, digital assistants, personal digital assistants, cellular phones, mobile phones, smart phones, pagers, digital tablets, laptop computers, Internet appliances, and other processor-based devices. In general, the client devices 102a-n may be any type of processor-based platform that operates on any suitable operating system, such as Microsoft® Windows® or Linux, capable of supporting one or more client application programs. For example, the client device 102a can comprise a personal computer executing client application programs, also known as client applications 120. The client applications 120 can be contained in memory 108 and can include, for example, a word processing application, a spreadsheet application, an email application, an instant messenger application, a presentation application, an Internet browser application, a calendar/organizer application, a video playing application, an audio playing application, an image display application, a file management program, an operating system shell, and other applications capable of being executed by a client device. Client applications may also include client-side applications that interact with or accesses other applications (such as, for example, a web-browser executing on the client device 102a that interacts with a remote e-mail server to access e-mail).

The user 112a can interact with the various client applications 120 and articles associated with the client applications 120 via various input and output devices of the client device 102a. Articles include, for example, word processor documents, spreadsheet documents, presentation documents, emails, instant messenger messages, database entries, calendar entries, appointment entries, task manager entries, source code files, and other client application program content, files, messages, items, web pages of various formats, such as HTML, XML, XHTML, Portable Document Format (PDF) files, and media files, such as image files, audio files, and video files, or any other documents or items or groups of documents or items or information of any suitable type whatsoever.

The user's 112a interaction with articles, the client applications 120, and the client device 102a creates event data that may be observed, recorded, analyzed or otherwise used. An event can be any occurrence possible associated with an article, client application 120, or client device 102a, such as inputting text in an article, displaying an article on a display device, sending an article, receiving an article, manipulating an input device, opening an article, saving an article, printing an article, closing an article, opening a client application program, closing a client application program, idle time, processor load, disk access, memory usage, bringing a client application program to the foreground, changing visual display details of the application (such as resizing or minimizing) and any other suitable occurrence associated with an article, a client application program, or the client device whatsoever. Additionally, event data can be generated when the client device 102a interacts with an article independent of the user 112a, such as when receiving an email or performing a scheduled task.

The memory 108 of the client device 102a shown also contains a capture processor 124, a queue 126, a web server 127, and a search engine 122. According to some embodiments, the queue 126 or the web server 127 may not be present. The client device 102a shown also contains or is in communication with a data store 140. The capture processor 124 can capture events and pass them to the queue 126 or to a web server 127, for example through a web services API. The queue 126 can pass the captured events to the search engine 122 or the search engine 122 can retrieve new events from the queue 126. In one embodiment, the queue 126 notifies the search engine 122 when a new event arrives in the queue 126 and the search engine 122 retrieves the event (or events) from the queue 126 when the search engine 122 is ready to process the event (or events). When the search engine receives an event it can be processed and can be stored in the data store 140. The search engine 122 can receive an explicit query from the user 112a or generate an implicit query and it can retrieve information from the data store 140 in response to the query. In another embodiment, the queue is located in the search engine 122. In still another embodiment, the client device 102a does not have a queue and the events are passed from the capture processor 124 directly to the search engine 122. According to other embodiments, the event data is transferred using an information exchange protocol. The information exchange protocol can comprise, for example, any suitable rule or convention facilitating data exchange, and can include, for example, any one of the following communication mechanisms: Extensible Markup Language-Remote Procedure Calling protocol (XML/RPC), Hypertext Transfer Protocol (HTTP), Simple Object Access Protocol (SOAP), shared memory, sockets, local or remote procedure calling, or any other suitable information exchange mechanism.

The capture processor 124 can capture an event by identifying and compiling event data associated with an event. Examples of events include sending or receiving an email message, a user viewing a web page, saving a word processing document, printing a spreadsheet document, inputting text to compose or edit an email, opening a presentation application, closing an instant messenger application, entering a keystroke, moving the mouse, and hovering the mouse over a hyperlink. An example of event data captured by the capture processor 124 for an event involving the receipt of an email message by the user 112a can comprise the sender of the message, the recipients of the message, the time and date the message was received, and the content of the message. Event data for an event can also include location information associated with the location of the client device when the event occurred. Location information can include one or more of a local time, location coordinates, a geographical location, and/or a physical location. Location coordinates can include latitude and longitude coordinates and/or grid coordinates of the client device. The geographical location can include a city, state and/or country. The physical location can include the user's home, the user's office, and a particular location, such as, for example an airport or a restaurant.

In the embodiment shown in FIG. 1, the capture processor 124 comprises multiple capture components. For example, the capture processor 124 shown in FIG. 1 comprises a separate capture component for each client application in order to capture events associated with each application. The capture processor 124 can also comprises a separate capture component that monitors overall network activity in order to capture event data associated with network activity, such as the receipt or sending of an instant messenger message. The capture processor 124 shown in FIG. 1 also can comprise a separate client device capture component that monitors overall client device performance data, such as processor load, idle time, disk access, the client applications in use, and the amount of memory available. The capture processor 124 shown in FIG. 1 also comprises a separate capture component to monitor and capture keystrokes input by the user and a separate capture component to monitor and capture items, such as text, displayed on a display device associated with the client device 102a. An individual capture component can monitor multiple client applications and multiple capture components can monitor different aspects of a single client application.

In one embodiment, the capture processor 124, through the individual capture components, can monitor activity on the client device and can capture events by a generalized event definition and registration mechanism, such as an event schema. Each capture component can define its own event schema or can use a predefined one. Event schemas can differ depending on the client application or activity the capture component is monitoring. Generally, the event schema can describe the format for an event, for example, by providing fields for event data associated with the event (such as the time of the event) and fields related to any associated article (such as the title) as well as the content of any associated article (such as the document body). An event schema can describe the format for any suitable event data that relates to an event. For example, an event schema for an email message event received by the user 112a can include the sender, the recipient or list of recipients, the time sent, the date sent, and the content of the message. An event schema for a web page currently being viewed by a user can include the Uniform Resource Locator (URL) of the web page, the time being viewed, and the content of the web page. An event schema for a word processing document being saved by a user can include the title of the document, the time saved, the format of the document, the text of the document, and the location of the document. More generally, an event schema can describe the state of the system around the time of the event. For example, an event schema can contain a URL for a web page event associated with a previous web page that the user navigated from. In addition, event schema can describe fields with more complicated structure like lists. For example, an event schema can contain fields that list multiple recipients. An event schema can also contain optional fields so that an application can include additional event data if desired. An event schema can also contain location information as described above.

The capture processor 124 can capture events occurring presently (or “real-time events”) and can capture events that have occurred in the past (or “historical events”). Real-time events can be “indexable” or “non-indexable”. In one embodiment, the search engine 122 indexes indexable real-time events, but does not index non-indexable real-time events. The search engine 122 may determine whether to index an event based on the importance of the event. Indexable real-time events can be more important events associated with an article, such as viewing a web page, loading or saving a file, and receiving or sending an instant message or email. Non-indexable events can be deemed not important enough by the search engine 122 to index and store the event, such as moving the mouse or selecting a portion of text in an article. Non-indexable events can be used by the search engine 122 to update the current user state. While all real-time events can relate to what the user is currently doing (or the current user state), indexable real-time events can be indexed and stored in the data store 140. Alternatively, the search engine 122 can index all real-time events. Real-time events can include, for example, sending or receiving an article, such as an instant messenger message, examining a portion of an article, such as selecting a portion of text or moving a mouse over a portion of a web page, changing an article, such as typing a word in an email or pasting a sentence in a word processing document, closing an article, such as closing an instant messenger window or changing an email message being viewed, loading, saving, opening, or viewing an article, such as a word processing document, web page, or email, listening to or saving an MP3 file or other audio/video file, or updating the metadata of an article, such as book marking a web page, printing a presentation document, deleting a word processing document, or moving a spreadsheet document.

Historical events are similar to indexable real-time events except that the event occurred before the installation of the search engine 122 or was otherwise not captured, because, for example, the search engine 122 was not operational for a period of time while the client device 102a was operational or because no capture component existed for a specific type of historical event at the time the event took place. Examples of historical events include the user's saved word processing documents, media files, presentation documents, calendar entries, and spreadsheet documents, the emails in a user's inbox, and the web pages bookmarked by the user. The capture processor 124 can capture historical events by periodically crawling the memory 108 and any associated data storage device for events not previously captured by the capture processor 124. The capture processor 124 can also capture historical events by requesting certain client applications, such as a web browser or an email application, to retrieve articles and other associated information. For example, the capture processor 124 can request that the web browser application obtain all viewed web pages by the user or request that the email application obtain all email messages associated with the user. These articles may not currently exist in memory 108 or on a storage device of the client device 102a. For example, the email application may have to retrieve emails from a server device. In one embodiment, the search engine 122 indexes historical events.

In the embodiment shown in FIG. 1, events captured by the capture processor 124 are sent to the queue 126 in the format described by an event schema. The capture processor 124 can also send performance data to the queue 126. Examples of performance data include current processor load, average processor load over a predetermined period of time, idle time, disk access, the client applications in use, and the amount of memory available. Performance data can also be provided by specific performance monitoring components, some of which may be part of the search engine 122, for example. The performance data in the queue 126 can be retrieved by the search engine 122 and the capture components of the capture processor 124. For example, capture components can retrieve the performance data to alter how many events are sent to the queue 126 or how detailed the events are that are sent (fewer or smaller events when the system is busy) or how frequently events are sent (events are sent less often when the system is busy or there are too many events waiting to be processed). The search engine 122 can use performance data to determine when it indexes various events and when and how often it issues implicit queries.

In one embodiment, the queue 126 holds events until the search engine 122 is ready to process an event or events. Alternatively, the queue 126 uses the performance data to help determine how quickly to provide the events to the search engine 122. The queue 126 can comprise one or more separate queues including a user state queue and an index queue. The index queue can queue indexable events, for example. Alternatively, the queue 126 can have additional queues or comprise a single queue. The queue 126 can be implemented as a circular priority queue using memory mapped files. The queue can be a multiple priority queue where higher priority events are served before lower priority events, and other components may be able to specify the type of events they are interested in. Generally, real-time events can be given higher priority than historical events, and indexable events can be given higher priority than non-indexable real-time events. Other implementations of the queue 126 are possible. In another embodiment, the client device 102a does not have a queue 126. In this embodiment, events are passed directly from the capture processor to the search engine 122. In another embodiment, events captured by the capture processor 124 are sent to the web server 127 using web services APIs. The web server 127 can then pass the events to the search engine 122. In other embodiments, events can be transferred between the capture components and the search engine using suitable information exchange mechanisms such as: Extensible Markup Language-Remote Procedure Calling protocol (XML/RPC), Hypertext Transfer Protocol (HTTP), Simple Object Access Protocol (SOAP), shared memory, sockets, local or remote procedure calling, or any other suitable information exchange mechanism.

The search engine 122 can contain an indexer 130, a query system 132, and a formatter 134. The query system 132 can retrieve real-time events and performance data from the queue 126. The query system 132 can use performance data and real-time events to update the current user state and generate an implicit query. An implicit query can be an automatically generated query based on the current user state. The query system 132 can also receive and process explicit queries from the user 112a. Performance data can also be retrieved by the search engine 122 from the queue 126 for use in determining the amount of activity possible by the search engine 122.

In the embodiment shown in FIG. 1, indexable real-time events and historical events (indexable events) are retrieved from the queue 126 by the indexer 130. Alternatively, the queue 126 may send the indexable events to the indexer 130. The indexer 130 can index the indexable events and can send them to the data store 140 where they are stored. The data store 140 can be any type of computer-readable media and can be integrated with the client device 102a, such as a hard drive, or external to the client device 102a, such as an external hard drive or on another data storage device accessed through the network 106. The data store can be one or more logical or physical storage areas. In one embodiment, the data store 140 can be in memory 108. The data store 140 may facilitate one or a combination of methods for storing data, including without limitation, arrays, hash tables, lists, and pairs, and may include compression and encryption. In the embodiment shown in FIG. 1, the data store comprises an index 142, a database 144 and a repository 146.

In one embodiment, when the indexer 130 receives an event, the indexer 130 can determine, from the event, terms (if any) associated with the event, location information associated with the event (if available), the time of the event (if available), images (if any) associated with the event, and/or other information defining the event. The indexer 130 can also determine if the event relates to other events and associate the event with related events. For example, for a received email event, the indexer 130 can associate the email event with other message events from the same conversation or string. The emails from the same conversation can be associated with each other in a related events object, which can be stored in the data store 140.

The indexer 130 can send and incorporate the terms and location information, associated with the event in the index 142 of the data store 140. The event can be sent to the database 144 for storage and the content of the associated article and any associated images can be stored in the repository 146. The conversation object associated with email messages can be stored in the database 144.

In the embodiment shown in FIG. 1, a user 112a can input an explicit query into a search engine interface displayed on the client device 102a, which is received by the search engine 122. The search engine 122 can also generate an implicit query based on a current user state, which can be determined by the query system 132 from real-time events. Based on the query, the query system 132 can locate relevant information in the data store 140 and provide a result set. In one embodiment, the result set comprises article identifiers for articles associated with the client applications 120 or client articles. Client articles include articles associated with the user 112a or client device 102a, such as the user's emails, word processing documents, instant messenger messages, previously viewed web pages and any other article or portion of an article associated with the client device 102a or user 112a. An article identifier may be, for example, a Uniform Resource Locator (URL), a file name, a link, an icon, a path for a local file, or other suitable information that may identify an article. In another embodiment, the result set also comprises article identifiers for articles located on the network 106 or network articles located by a search engine on a server device. Network articles include articles located on the network 106 not previously viewed or otherwise referenced by the user 112a, such as web pages not previously viewed by the user 112a.

The formatter 134 can receive the search result set from the query system 132 of the search engine 122 and can format the results for output to a display processor 128. In one embodiment, the formatter 134 can format the results in XML, HTML, or tab delineated text. The display processor 128 can be contained in memory 108 and can control the display of the result set on a display device associated with the client device 102a. The display processor 128 may comprise various components. For example, in one embodiment, the display processor 128 comprises a Hypertext Transfer Protocol (HTTP) server that receives requests for information and responds by constructing and transmitting Hypertext Markup Language (HTML) pages. In one such embodiment, the HTTP server comprises a scaled-down version of the Apache Web server. The display processor 128 can be associated with a set of APIs to allow various applications to receive the results and display them in various formats. The display APIs can be implemented in various ways, including as, for example, DLL exports, COM interface, VB, JAVA, or NET libraries, or a web service.

Through the client devices 102a-n, users 112a-n can communicate over the network 106, with each other and with other systems and devices coupled to the network 106. As shown in FIG. 1, a server device 150 can be coupled to the network 106. In the embodiment shown in FIG. 1, the search engine 122 can transmit a search query comprised of an explicit or implicit query or both to the server device 150. The user 112a can also enter a search query in a search engine interface, which can be transmitted to the server device 150 by the client device 102a via the network 106. In another embodiment, the query signal may instead be sent to a proxy server (not shown), which then transmits the query signal to server device 150. Other configurations are also possible.

The server device 150 can include a server executing a search engine application program, such as the Google™ search engine. In other embodiments, the server device 150 can comprise a related information server or an advertising server. Similar to the client devices 102a-n, the server device 150 can include a processor 160 coupled to a computer-readable memory 162. Server device 150, depicted as a single computer system, may be implemented as a network of computer processors. Examples of a server device 150 are servers, mainframe computers, networked computers, a processor-based device, and similar types of systems and devices. The server processor 160 can be any of a number of computer processors, such as processors from Intel Corporation of Santa Clara, Calif. and Motorola Corporation of Schaumburg, Ill. In another embodiment, the server device 150 may exist on a client-device. In still another embodiment, there can be multiple server devices 150.

Memory 162 contains the search engine application program, also known as a network search engine 170. The search engine 170 can locate relevant information from the network 106 in response to a search query from a client device 102a. The search engine 170 then can provide a result set to the client device 102a via the network 106. The result set can comprise one or more article identifiers. An article identifier may be, for example, a Uniform Resource Locator (URL), a file name, a link, an icon, a path for a local file, or anything else that identifies an article. In one embodiment, an article identifier can comprise a URL associated with an article.

In one embodiment, the server device 150, or related device, has previously performed a crawl of the network 106 to locate articles, such as web pages, stored at other devices or systems coupled to the network 106, and indexed the articles in memory 162 or on another data storage device.

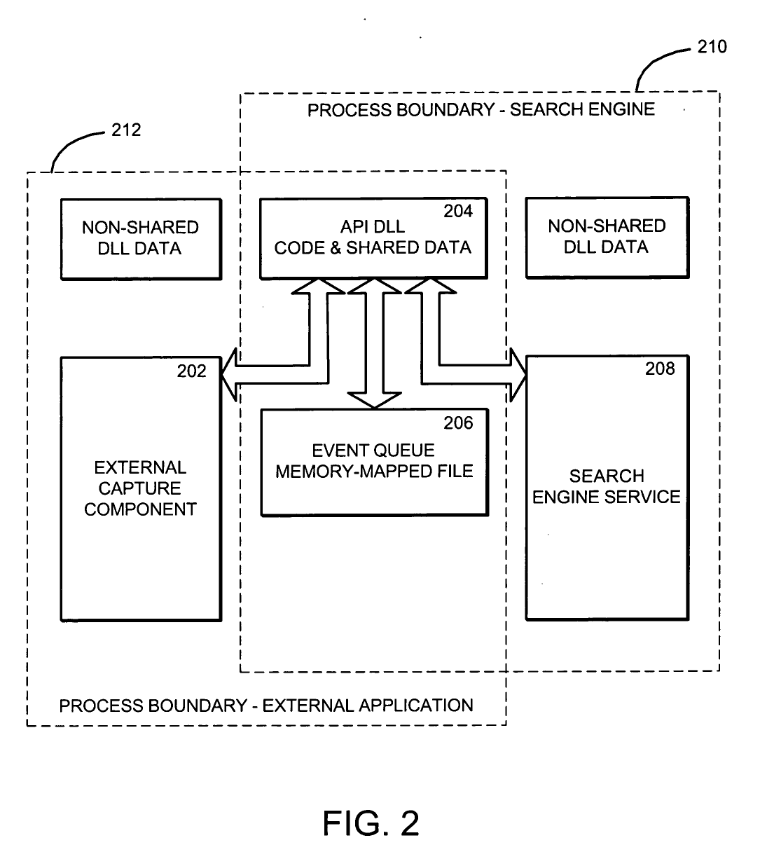

It should be noted that other embodiments of the present invention may comprise systems having different architecture than that which is shown in FIG. 1. For example, in some other embodiments of the present invention, the client device 102a is a stand-alone device that is not permanently coupled to a network. The system 100 shown in FIG. 1 is merely exemplary, and is used to explain the exemplary methods shown in FIG. 2.

The capture components discussed above in connection with FIG. 1 are exemplary capture components that work with a set of predefined applications. Usually those applications use a predefined set of registered event schemas originally included with the search engine application. The search engine application also comprises a set of Application Programming Interfaces (API). The APIs allow an application capture component to retrieve existing event schemas, to register new events schemas customized for a particular application, to identify events and articles associated with the application, to create events based on an event schema, to send events to the search engine and generally to send and receive any other suitable information such as performance data, application state or search engine parameters.

An application capture component can define and register an event schema for each of the types of events and articles that it intends to send to the search engine. The use of the term “event schema” herein is intended to apply to a schema that is related to either an event or an article. The event schema can be based on one of the predefined event schemas provided by the search engine or can be unique to a particular application. In one embodiment, an application capture component captures real-time events, both contextual and indexable events, and historical events in a manner similar to that discussed above in connection with FIG. 1.

In one embodiment, application capture components communicate with the search engine using the capture component Application Programming Interface (APIs). FIG. 2 illustrates a possible implementation of the communication between an application capture component 202 and the search engine. The APIs between the capture component and the search engine can be implemented in a DLL (dynamic link library) which can minimize the memory working set. The APIs can be exposed as DLL exports or COM (Component Object Model) interfaces using standard operating system techniques. The DLL 204 is mapped to an address space associated with both the search engine 210 and the application 212 to permit sharing of certain data structures. As shown in FIG. 2 the application is associated with a capture component 202 and the search engine is associated with a search engine service component 208. The capture component communicates with the search engine service component using the event queue 206 and the APIs 204 shown in FIG. 2.

In one embodiment, the event queue 206 is a shared memory queue that is implemented as a circular priority queue using memory mapped files. In one embodiment, when the queue is full, messages are cached on disk. In one embodiment, the event queue is implemented as two queues, one queue for contextual events and one queue for indexable events. In this embodiment, the indexable queue is a two-priority queue where higher priority events are served before lower priority events. Generally, real-time events are given higher priority than historical events.

In another embodiment the programming interface between an application capture component 202 and the search engine 208 is implemented using basic operating system services such as Remote Procedure Calls (RPC), windows messages or sockets.

In another embodiment the communication between an application capture component 202 and the search engine is achieved through a web server. The APIs are implemented as a web service. The web service can expose several multi-language interfaces based on web information exchange protocols such as SOAP (Simple Object Access Protocol). The capture component can use any suitable language to call into the web service.

### Processes

Various methods in accordance with the present invention may be carried out. For example, one embodiment comprises a method for determining an event schema for an application, and determining event data for an event, based at least in part on the event schema, wherein the event relates to user interactions with an article associated with the application. According to other embodiments, the method may further comprise transferring the event data to a search engine application and storing the event data in a searchable database, wherein the events and articles associated with the application are searchable by a search application. According to other embodiments, determining the event schema can comprise one of either receiving, creating or providing the event schema. According to other embodiments determining the event schema comprises accessing a registered event schema. According to other embodiments, the registered events schema can comprise an event schema indicating information to be captured for a designated application or class of applications on a client device. According to other embodiments, the event schema can comprise an extension of a registered event schema. According to some embodiments, the registered event schema can have different versions. According to some embodiments, the registered event schema can be an extension of a predefined base event schema provided by a search application. According to some embodiments, the event relates to a current user state associated with the application or to user interaction with an article associated with the application. According to some embodiments, determining an event schema can comprise registering a new event schema. According to other embodiments, the event data can be transferred using one or a combination of the following information exchange mechanisms: Extensible Markup Language-Remote Procedure Calling protocol (XML/RPC), Hypertext Transfer Protocol (HTTP), Simple Object Access Protocol (SOAP), shared memory, sockets, local or remote procedure calling, or any other information exchange mechanism.

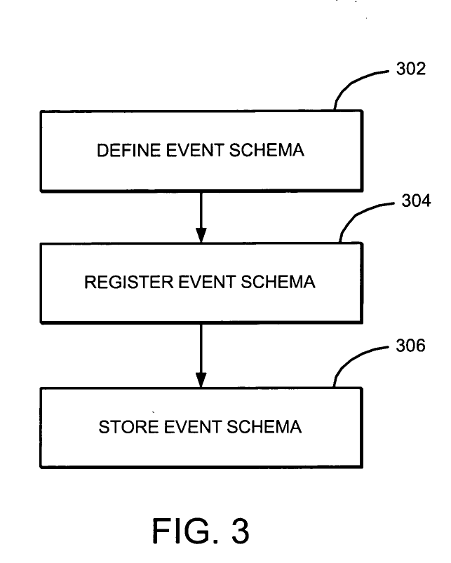

FIG. 3 illustrates an exemplary method for an application capture component to register a new event schema. In block 302, the new event schema is defined by the application capture component. The new event schema can be defined by extending an existing schema of a set of already registered event schemas. The set of registered event schemas can comprise, for example, predefined base event schemas included with a search application, or schemas registered by different application capture components defining types of event data associated with those applications. Preferably, the predefined base event schemas include basic event schemas for a number of events, including, for example, e-mail events, web page events, instant messaging events, file events and context events. An application capture component can use any registered event schemas directly, including search application predefined schemas, or it can create and register a new event schema by extending an already registered schema with additional application-specific fields. An advantage of using a schema based on one of the predefined schemas is that the specialized field processing associated with the predefined schema is available. For example, the event schema for an email event can include sender information, recipient information, time that the email message was received, a date that the email message was received, the subject of the email message, and the content of the email message. The events schema can also comprise optional fields. Optional fields can allow the selective capture of information associated with an article. Alternatively, the event schema can be a unique event schema that is defined by the capture component. The unique event schema can comprise, for example, an event schema created for a new application. Typically an event schema is identified by a unique name and defines an event by defining one or more fields associated with data related to the event, an article associated with the event, and/or the content of the article. For example, a new media application, such as an mp3 player, can be installed on the client device 102a. A capture component associated with the new application can create an event schema based specifically on events possible in the new mp3 player application, or a subset thereof. For example, the mp3 player can allow a song to be downloaded, assigned a label, and copied to a CD. The capture component associated with the mp3 application can create an event schema including location information of the downloaded song, a name of the label assigned to the song, a time indicating when the song was copied to the CD, an artist of the song an album associated with the song, a genre for the song and other suitable information. Predefined, extended and unique event schemas can be used for both historical and/or real-time events.

Once the application capture component defines the new event schema at 302, the capture component registers the event schema with the search engine at 304. Registering the event schema can comprise, for example, associating a schema ID with the new event schema and storing the event schema and event schema ID in the data store 140 or other suitable location. The event schema ID can comprise, for example, a unique identifier, such as a number, associated with the new event schema. Registering the new event schema allows the capture components and the search engine to determine types of event data associated with an event. Registering the new event schema also allows other capture components to use the new schema. Registering the event schema can also determine a particular event schema for use with an application or class of applications on a client device. For example registering a word processing event schema can allow all or some of the word processing applications on the client device 102a to use the schema to capture specific events. Alternatively, each word processing application can define and register its own event schema. In another example, an application capture component for an e-mail program on the client device 102a can register a new email event schema by extending a predefined email event schema and adding additional fields, for example an e-mail summary field and an e-mail importance field. Capture components for email applications that provide such summary and e-mail importance information, such as Eudora or Outlook, can use the new registered schema to send the search engine additional information about the email message.

In one embodiment the capture component registers the event schema using the APIs. In another embodiment the event schema is registered using an event schema registration utility. Once the event schema is registered, then the search engine stores the event schema at 306. The event schema can be stored in the data store 140, for example, or any other suitable location.

According to another embodiment a capture component or the search engine can add fields to a registered event schema and still retain the same schema name. In one embodiment, the appropriate version of an event schema is identified by the capture component when a new event is created. In another embodiment, the capture component does not identify a version. Instead, the most recent version of the schema is used and if there is no data for a field that was added to the most recent version, then the field is ignored by the search engine.

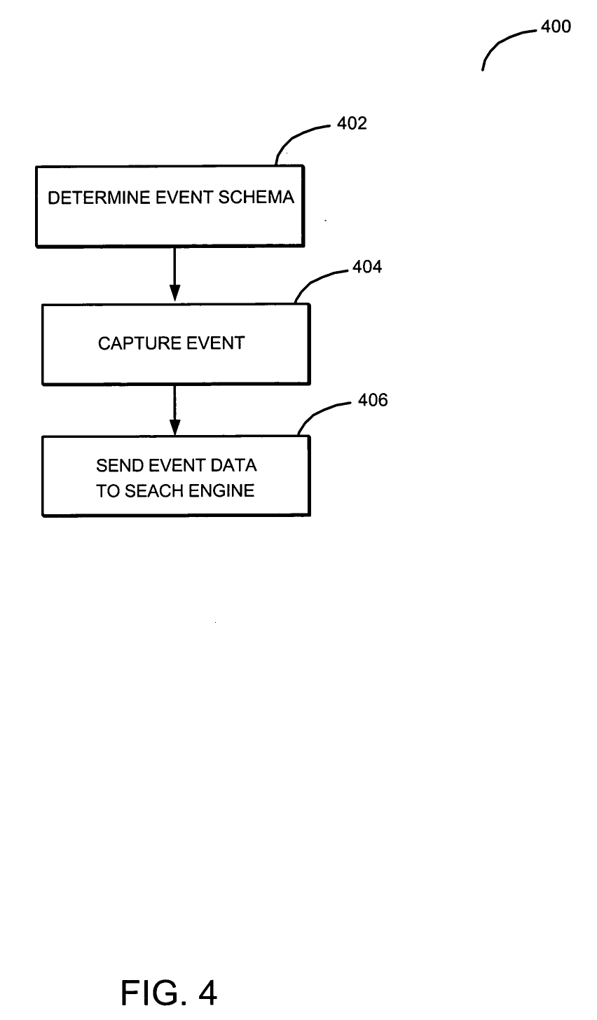

FIG. 4 illustrates an exemplary method for capturing and transmitting an event to the search engine 122. The method 400 begins in block 402, wherein the capture component determines an event schema. The capture component can determine an event schema by creating a new event schema, for example, according to one embodiment of the method 300 or by accessing a pre-existing event schema indexed and stored, for example, in the data store 140. The capture component can determine an event schema associated with an application from which events are being generated. For example, if the user 112a is sending an email, an email event can be generated. The capture component can then determine an email schema associated with the application which the user 112a is using to send the email.

Once the capture component determines an event schema, the method 400 proceeds to block 404 wherein the capture component captures an event. In block 406, the capture component captures an event by compiling event data associated with the event. The capture component can compile the event data based on the event schema using, for example, a “create compiled event” API. The “create compiled event” API can comprise, for example, an API that returns an “event handle” to the capture component. The “event handle” can be used by the capture component to determine event data associated with an event. The capture component can then invoke a “property setter” API. The “property setter” API can comprise, for example, an API configured to compile the event data associated with an event based on the event schema. For example the user 112a can download a song using an mp3 media application. The capture component can compile event data associated with downloading the song by loading an mp3 event schema and then using the “create compiled event” and “property setter” APIs to determine from the mp3 media application the name of the downloaded song, the path where the song was stored, the artist of the song, and other song information indicated in the mp3 event schema.

Once the capture component compiles event data associated with an event, the method 400 proceeds to block 406, wherein the capture component transfers the event data to the search engine 122 via the event queue at 126. In one embodiment, a “send” API encodes the event object as a variable length byte stream before placing it in the event queue 206. Encoding the event data as a variable length byte stream can comprise configuring the event data to minimize system resource requirements for transferring and storing an event. The indexer 130 can retrieve the event from the event queue 126 using, for example, a “retrieve” API. The retrieve API can be configured to allow the indexer 130 to receive event data from the queue 126 based on availability of system resources. In another embodiment, the event data can be sent to the indexer 130 using a web service API or XML encoding. Transferring the event data using a web service API or XML encoding can comprise posting the data via Hypertext Transfer Protocol (HTTP). In other embodiments the event data is transferred using one or a combination of the following information exchange mechanisms: Extensible Markup Language-Remote Procedure Calling protocol (XML/RPC), Hypertext Transfer Protocol (HTTP), Simple Object Access Protocol (SOAP), shared memory, sockets, local or remote procedure calling, or any other information exchange mechanism.

### General

While the foregoing description contains many specifics, these specifics should not be construed as limitations on the scope of the invention, but merely as exemplifications of the disclosed embodiments. Additional alternative embodiments will be apparent to those skilled in the art to which the present invention pertains without departing from its spirit and scope. Accordingly, the scope of the present invention is described by the appended claims (as may be amended, reissued, and subsequently added) and is supported by the foregoing description.

1. A method comprising:
determining an event schema for an application; and
determining event data for an event, based at least in part on the event schema,
wherein the event relates to user interactions with an article associated with the application.

2. The method of claim 1, further comprising transferring the event data to a search application.

3. The method of claim 1, further comprising storing the event data in a searchable database, wherein the events and articles associated with the application are searchable by a search application.

4. The method of claim 1, wherein determining the event schema comprises one of either receiving, creating, or providing the event schema.

5. The method of claim 1, wherein determining the event schema comprises accessing a registered event schema.

6. The method of claim 5, wherein the registered event schema comprises an event schema indicating information to be captured for a designated application or class of applications on a client device.

7. The method of claim 5, wherein the registered event schema is an extension of another registered event schema.

8. The method of claim 5, wherein the registered event schema has different versions.

9. The method of claim 5, wherein the registered event schema is an extension of a predefined base event schema provided by a search application.

10. The method of claim 1, wherein the event relates to a current user state associated with the application.

11. The method of claim 1, wherein determining an event schema comprises registering a new event schema.

12. The method of claim 1, wherein the event data is transferred using one or a combination of the following information exchange mechanisms: Extensible Markup Language-Remote Procedure Calling protocol (XML/RPC), Hypertext Transfer Protocol(HTTP), Simple Object Access Protocol (SOAP), shared memory, sockets, local or remote procedure calling.

13. A computer readable medium containing program code comprising:
determining an event schema for an application, wherein the application has associated articles; and
determining event data for an event, based at least in part on the event schema,
wherein the event relates to user interactions with an article associated with the application.

14. The computer readable medium of claim 13, further comprising program code for transferring the event data to a search application.

15. The computer readable medium of claim 13, further comprising program code for storing the event data in a searchable database, wherein the events and articles associated with the application are searchable by a search application.

16. The computer readable medium of claim 13, wherein determining the event schema comprises one of either receiving, creating, or providing the event schema.

17. The computer readable medium of claim 13, wherein determining the event schema comprises accessing a registered event schema.

18. The computer readable medium of claim 17, wherein the registered event schema comprises an event schema indicating information to be captured for a designated application or class of applications on a client device.

19. The computer readable medium of claim 17, wherein the registered event schema is an extension of another registered event schema.

20. The computer readable medium of claim 17, wherein the registered event schema has different versions.

21. The computer readable medium of claim 17, wherein the registered event schema is an extension of a predefined base event schema provided by the search engine.

22. The computer readable medium of claim 13, wherein the event relates to a current user state associated with the application.

23. The computer readable medium of claim 13, wherein determining an event schema comprises registering a new event schema.

24. The computer readable medium of claim 13, wherein the event data is transferred using an information exchange protocol.

25. The computer readable medium of claim 13, wherein the event data is transferred using one or a combination of the following communication mechanisms: Extensible Markup Language-Remote Procedure Calling protocol (XML/RPC), Hypertext Transfer Protocol(HTTP), Simple Object Access Protocol (SOAP), shared memory, sockets, local or remote procedure calling.

26. A method comprising:
defining an event schema for an event wherein the event relates to user interactions with an article associated with an application;
registering an event schema for the application, wherein registering the event schema comprises indexing and storing the event schema;
determining a new event;
determining a registered event schema associated with the new event;
determining event data for the new event based at least in part on the event schema;
transferring the event data to a search application and storing the event in a searchable database, wherein the event and articles associated with the application can be searchable by a search application.

27. A system comprising:
a means for determining an event schema for an application; and
a means for determining event data for an event, based at least in part on the event schema, wherein the event relates to user interactions with an article associated with the application.

28. The system of claim 27, further comprising a means for transferring the event data to a search engine application

29. The system of claim 27, further comprising a means for storing the event data in a searchable database, wherein the events and articles associated with the application are searchable by a search application.

30. The system of claim 27, wherein the means for determining the event schema comprises a means for receiving, creating or providing the event schema.
